(19) United States
(12) Patent Application Publication
(10) Pub. No.: US 2015/0075798 A1
(43) Pub. Date: Mar. 19, 2015

(54) HYDROCARBON RECOVERY DISPERSIONS

(71) Applicant: ChemEOR, Inc., Covina, CA (US)

(72) Inventors: Yongchun TANG, Walnut, CA (US); Hongxin TANG, Walnut, CA (US); Panqing HE, Covina, CA (US)

(21) Appl. No.: 14/488,272

(22) Filed: Sep. 16, 2014

Related U.S. Application Data
(60) Provisional application No. 61/878,558, filed on Sep. 16, 2013.
(60) Provisional application No. 61/878,548, filed on Sep. 16, 2013.

(51) Int. Cl. C09K 8/588; E21B 43/26; E21B 43/16

(52) U.S. Cl. CPC C09K 8/588; E21B 43/16; E21B 43/26
USPC 166/307; 507/225; 166/308.2

(57) ABSTRACT

Compositions and dispersions comprising hydrophobically modified polyacrylamide (HMPAM) or associative polymers and small particles useful in hydrocarbon recovery and enhanced oil recovery processes using the same. Non-limiting embodiments include those using metal oxide small particles, including fumed silica having primary particles in the nanoparticle size range.

### CROSS-REFERENCE TO RELATED APPLICATIONS

This application claims the benefit of U.S. Provisional Application Nos. 61/878,558 and 61/878,548, both filed on Sep. 16, 2013; these are hereby incorporated by reference herein.

### BACKGROUND

Compositions and methods disclosed herein relate to chemicals and additives and their use in hydrocarbon recovery operations and production, particularly in enhanced oil recovery (EOR).

Three methods widely used in the discipline are polymer (P), surfactant (S), and alkali (A) flooding. Combinations of any of the two as well as all three are also used, abbreviated for example, in case where all three are used, as A/S/P or ASP, depending on whether separate slugs or a single slug is introduced. Flooding systems involving variations and various flushes are also used. The longstanding objective has been, and remains, to increase oil recovery by introducing cost effective additives in the secondary and/or tertiary stage, while minimizing side effects so as to improve incremental (over plain waterflood) or cumulative recovery economics. A flooding fluid that increases the recovery efficiency of any of the current systems would clearly contribute to improved recovery economics. We have discovered such a fluid composition comprising polymers and small particles, as will be further disclosed below.

In polymer flooding EOR operations, a major goal is to achieve a favorable mobility ratio, such that the mobility of the upstream displacing fluid is less than that of the downstream displaced fluid. Mathematically, if λ=k/μ (eq. 1) (where λ is the mobility, k permeability, and μ viscosity), then the goal is Mᵣ=λᵤ/λ_{d}≦1 (eq. 2) (where Mᵣ is the mobility ratio, and λᵤ and λ_{d} mobilities of the upstream displacing fluid and downstream displaced fluid respectively). It has been proposed that a more accurate mobility ratio is a unit mobility ratio, defined as the displacing fluid mobility divided by the oil mobility multiplied by oil saturation, taking into account relative permeabilities of water and oil. When the displacing fluid is a polymer solution (water phase), its viscosity can be adjusted to a target viscosity by varying the polymer type and/or concentration and other parameters, thus minimizing viscous fingering and bypassing of residual oil. All flooding techniques aim to increase macroscopic as well as microscopic sweep efficiencies, so as to lower residual oil saturation. Polymer flooding via mobility control has a substantial effect on macroscopic or volumetric sweep efficiency.

In surfactant flooding, a major goal is to decrease the (local) capillary force relative to the viscous force, F_{c} and Fᵥ respectively, through decreasing interfacial tension (IFT) between oil and the displacing fluid by aid of surfactants, such that the capillary number N_{C} increases, where N_{C}=Fᵥ/F_{c} (eq. 3). There are a number of forms of N_{C} that detail contributions to Fᵥ and F_{c}, all of which include σ, the IFT between the displacing and displaced fluid phases, as a key contribution to F_{c}. A simple and a fuller form of N_{C} are as follows: N_{C}=uμ/σ (eq. 4) (where u is the Darcy velocity, and μ the displacing fluid viscosity), and N_{C}=(−kΔΦₚ/ΔL)/σ (eq. 5) (where k is the permeability, Φₚ displacing fluid potential, and ΔΦₚ/ΔL potential gradient). Other forms of N_{C} take into account the characteristic pore size radius of the porous media, the pore neck and body radii, and whether single oil blobs or a continuous oil phase is to be displaced. A low or if possible ultralow oil/water phases IFT contributes to an increase in microscopic (displacement) efficiency.

In alkali flooding, alkaline agents introduced react with crude oil components such as naphthenic acids to form surfactants (soaps) in situ. These soaps are an additional source of surfactancy and modify IFTs at oil/rock interfaces, leading to the release of irreducible oil and oil displacement improvement. An important effect of alkalis is that they reduce surfactant adsorption by altering rock wettability. The alkalis can be alkali metal salts of carbonates, silicates, or hydroxides. Further general descriptions and background information concerning EOR operations and methods can be found in for example WO 2014/020061, the relevant disclosures of which are incorporated by reference as if fully set forth herein.

Partially hydrolyzed polyacrylamide (HPAM) polymers are widely used in the EOR industry for polymer flooding. A new class of HPAM polymers used for EOR is variously called hydrophobically modified polyacrylamide (HMPAM), hydrophobically associating (sometimes associative) polymers (HAP), or functionalized (sometimes functional) polymeric surfactants (FPS). These are water soluble polymers having a polyacrylamide or HPAM backbone that is functionalized by hydrophobic side chains, typically by including in the polymerization from about 0.1 mole % or less to about 15 mole % or even more of one or more hydrophobic monomers. Hydrophobic monomers are not easily water-soluble, and several synthetic strategies, including emulsion polymerization, exist to address this issue. Hydrophobically associating polymers (HAP) and functionalized polymeric surfactants (FPS) do not have to have a polyacrylamide or HPAM backbone, but when they do, “FPS” and especially “HAP” are sometimes taken to be synonyms for “HMPAM.” When successfully synthesized, the HMPAM class of polymers can form intermolecular associative networks in solution, as suggested by the description “hydrophobically associating polymers,” whereby the association contributes to an increased apparent viscosity. The moniker “functionalized polymeric surfactants,” on the other hand, underscores that from a polymerization process point of view these polymers can be made from polymerizable surfactants, and that the end product polymers can be surface active, with the hydrophobic segments oriented so as to be exposed to a lipophilic phase, thus contributing to interfacial phenomena or effects.

The detailed solution properties of specific HMPAM molecules vary and depend on a number of factors. One major factor is the balance of inter versus intra molecular association. Intramolecular hydrophobic association makes hydrophobic groups unavailable for intermolecular association. The balance between the two is determined by the chemical nature, extent of incorporation, and distribution of the hydrophobic groups along the backbone, and parameters external to the molecules. Salts in solution shield charged groups, for example acrylates on the HMPAM backbone, and therefore ionic repulsion, and compress the polymer molecular chains and lower viscosity. But salts also increase solvent polarity, which prevents chain compression and enhances hydrophobicity. HMPAM solutions can exhibit non-Newtonian rheological behaviors. They can also lead to oil/aqueous phases IFT decreases from moderate to considerable, to about 0.1 dyne/cm, or even lower depending on the nature of the polymer, type of crude oil, brine condition, and other factors.

A hydrophobic monomer comprises in significant proportions alkyl, aryl and/or aralkyl groups relative to other groups or functions within the monomer. The overall hydrophobicity of a given hydrophobic monomer can vary, modulated by charged or polar functions that may be present as part of the hydrophobic monomer at internal and/or terminal positions. A hydrophobic monomer can be one comprising a hydrophobic moiety selected from the group consisting of anionic, cationic, nonionic, zwitterionic, betaine, and amphoteric ion pair.

Properties of HMPAM and associative polymers are described in the art. Examples follow. Pancharoen compared four commercial EOR polymers, three HMPAMs vs. one conventional HPAM, and examined their IFT and through sandpacked column experiments permeability reduction and inaccessible pore volume (Pancharoen, M. “Physical Properties of Associative Polymer Solutions,” Thesis, Stanford University (2009)). Thomas discloses that associative polymers have increased viscosity and resistance factors, and their intermolecular association is reversible and can be controlled by shear rate or surfactant amount; it states that viscoelasticity of high MW associative polymers “may also contribute to recover[ing] additional entrapped oil compared to a conventional Newtonian fluid injection, but there is some controversy whether it applies to real reservoir conditions or not” (Thomas, A. et al., Oil & Gas Sci. Technol.—Rev. IFP Energies nouvelles 67: 887-902 (2012)). U.S. patent application Ser. No. 12/429,137 discloses functional polymeric surfactants (FPS) used for hydrocarbon recovery, which incorporate various hydrophobic and hydrophilic moieties and bring about an IFT of 0.1-15 dyne/cm between the water and hydrocarbon phases. Elraies discloses using sodium methyl ester sulfonates (SMES) (derived from Jatropha oil fatty acid methyl esters) to produce polyacrylamide-backboned polymeric methyl ester sulfonates (PMES), which are used for IFT reduction and viscosity control in oil recovery (Elraies, K. A. and Tan, I. “The Application of a New Polymeric Surfactant for Chemical EOR.” in: Romero-Zerón, L. (ed.), Introduction to Enhanced Oil Recovery (EOR) Processes and Bioremediation of Oil-Contaminated Sites, 2012). Other examples of HMPAM are described by Wever as part of a review of the structure-property relationship, synthetic methods, and solution properties of classic and novel associating water-soluble polymers used for EOR (Wever, D. et al. Progress in Polymer Science 36: 1558-1628 (2011)). An example of a more fundamental and theoretical study of polymer solutions properties is that by Dobrynin, where for a semidilute high molecular weight polyelectrolyte solution or dispersion in the presence of salts, viscosities are approximated in the unentangled and entangled regimes to scale as a power of monomer concentration (number density) (Dobrynin, A. et al. Macromolecules 28: 1859-1871 (1995)).

HMPAM constitutes only one of the synthetic structures practiced in the art in making an associative type EOR polymer. Other associative type water-soluble thickening polymers with different backbone structures are known and studied in the art, including hydrophobically modified ethoxylated urethane (HEUR), hydrophobically modified alkali swellable emulsion (HASE), and various hydrophobically modified cellulose derivatives (e.g., hydrophobically modified hydroxyethylcellulose, HMHEC), all reviewed by Wever.

Nanoparticle (NP) technology applications in the field of hydrocarbon recovery and production developed somewhat recently. It is thought that small particles in the nanometer and submicron ranges can be used to improve either the properties of the injected fluid or those of the fluid-porous media interaction, or both. But much unpredictability remains, as basic properties of NPs in fluids are not fully understood. For example, while describing a viscosity model for nanofluids (i.e., NP-containing fluids) that accounts for NP size, Rudyak notes, “viscosity of nanofluids has been persistently investigated over about fifteen years in more than thirty groups throughout the world. However, a universal formula that would describe the viscosity coefficient of any nanofluid has not been derived. Moreover, measurements often lead to diametrically opposite results” (Rudyak, V. Advances in Nanoparticles 2: 266-279 (2013)). Rudyak and Genovese both analyze from a theoretical perspective the shear rheology of NP-containing fluids and composites, presenting predictive curves of fundamental rheological properties vs. particle size, volume fraction, and shear rate based on theoretical or (semi)empirical models and experimental data (Rudyak, V. as above; Genovese, D. Advances in Colloidal and Interface Science 171-172: 1-16 (2012)).

Properties of NP-containing fluids, especially if relatively dilute, are sometimes not clearly dissimilar from fluids containing somewhat larger colloidal-sized particles. A particles dispersion or suspension (i.e., a coarse dispersion) comprising particles in the 1-1000 nm size range is a complex colloidal fluid system. (And more so a polymer-particles dispersion, and if the dispersion were transported through a porous medium, the phenomena would be even more multifaceted.) For a flowing colloidal system containing particles in the 1-1000 nm size range (up to 10 micron sometimes), three types of forces and a balance among them determine many of the properties of the system: hydrodynamic (or viscous), Brownian, and interparticle (or colloidal). Especially significant among the interparticle forces are electrostatic interactions (attractive or repulsive, the latter stabilizing), van der Waals attractions, and when polymer or surfactant layers are present steric interactions. The Einstein equation ηᵣ=1+[η]φ (eq. 6) is only the simplest description of a particles dispersion's hydrodynamics (where ηr is the relative viscosity, [η] the particle shape-dependent intrinsic viscosity (being 2.5 for rigid spheres), and φ the volume fraction of dispersed particles). It does not account for Brownian or interparticle forces. That is, it is only valid for very dilute non-Brownian hard-sphere (i.e., non-colloidal) dispersions. To describe the effect of higher particle concentrations on viscosity (shear rate-dependent as a consequence), and the effects of particle associated factors (shape, size distribution, and deformability) and Brownian motion, a number of semi-empirical models have been developed. One of these for example is a modified Krieger Dougherty model formulated in terms of the Péclet number Pe, which in the present context characterizes the magnitude of the hydrodynamic force relative to the Brownian motion thermal force. These basic theoretical considerations show that it would be difficult to predict from them alone the extent of hydrocarbon recovery from a hydrocarbon-bearing porous medium by a polymer—small particles dispersion. Viscosity under some circumstances can be predicted with some accuracy, but rheology, though centrally important, is not the only relevant parameter. So too are interfacial effects, wettability, and pore geometry.

Much art in basic research concerning the rheological and other properties of NP and colloidal particles fluids in various base solvents, without polymers present or with, are known and continue to be generated. This line of art references however does not address or show how the fluids studied can be used to recover oil from a porous medium. The variety of polymers studied with respect to chemical structure, composition, and MW is also great. They do show that a polymer solution can flocculate a NP or colloidal dispersion by depletion or bridging or other mechanisms, and the extent and possibility of bridging is sensitive to polymer and particle (cluster) type and size. Examples include the following: Horigome, M. and Otsubo, Y. Langmuir 18: 1968-1973 (2002); Kamibayashi, M. et al. Ind. Eng. Chem. Res. 45: 6899-6905 (2006); Berret, J.-F., et al. J. Phys. Chem. B 110: 19140-19146 (2006); Kohli, I. and Mukhopadhyay, A. Macromolecules 45: 6143-6149 (2012); Mun, E. et al. Langmuir 30: 308-317 (2014); Tadano, T. et al., Polymer Journal 46: 342-348 (2014).

Empirical art pertinent to EOR applications includes Ogolo, which describes oil recovery experiments via sandpacks by several metal oxide NP dispersions, using distilled water, brine, ethanol, and diesel as bases (Ogolo, N. et al., SPE 160847, Society of Petroleum Engineers (2012)). It was noted that results from these diverse dispersing phase/metal oxide combinations “[emphasize] the significant role a fluid plays as a nanoparticle dispersing agent in the formation[,] because it can contribute positively or negatively in oil recovery apart from the effect of the nanoparticles.” Ogolo also teaches that “polymers are known agents that have been used to increase the viscosity of displacing fluids. The disadvantages associated with polymers include loss of some fluid properties at high temperatures, cost and quantity required to accomplish a task. On the other hand, nanoparticle applications require small quantities to perform a task since it has large surface areas.” These teachings consider polymer- and NP-containing displacing fluids as separate treatments, and emphasize that EOR results from even a dispersion containing only NPs are unpredictable, depending significantly on how the particles are dispersed and the dispersing fluid.

Li shows by coreflood experiments that a silica hydrophilic NP suspension is effective in oil recovery, but that recovery decreases beyond a critical particles concentration (Li, S. et al., IPTC 16707, International Petroleum Technology Conference (2013)). Skauge shows, however, that NPs do not mobilize oil from water-wet Berea sandstone cores, but when dispersed in a 600 ppm conventional HPAM solution do so (Skauge, T. et al., SPE 129933, Society of Petroleum Engineers, (2010)). Surprisingly, no control using a solution containing only 600 ppm HPAM was performed, thus it cannot be known whether oil mobilization was due solely to the HPAM polymer. They describe possible oil recovery mechanisms other than macroscopic viscosity modification and more applicable to cases involving small particles, including log jamming and straining (both entrapment mechanisms), adsorption, and disjoining pressure gradient.

U.S. Pat. No. 6,586,371 discloses a fluid which viscosity is controlled by a system of copolymer and precipitated silica NPs. The copolymer is formed from majority acrylamide or (meth)acrylic acid monomers, and a second type of water soluble and generally polar monomer such as vinylpyrrolidone in the minority. Precipitated silica is required, and it is noted that “systems prepared with Aerosil silicas such as Aerosil 380 hydrophilic silica sold by DEGUSSA CO, with a specific surface area of 380±30 m²/g and a diameter of 7 nm, did not exhibit any rheo-viscosifying phenomenon.” And WO2014/020061 discloses a shear thickening formulation used in EOR comprising polyethylene oxide and silica having primary particle sizes of 1-20 nm.

Further relevant art in related areas include the following. NPs have been used to stabilize O/W emulsions in the oil industry as a development of Pickering emulsions, as described by Zhang and Roberts for example (Zhang, T. et al., SPE 129885, Society of Petroleum Engineers (2010); Roberts, M. et al., SPE 154228, Society of Petroleum Engineers (2012)). However, such (colloidal or nano) particle-stabilized emulsions are both a hindrance and a potential tool in the oil industry, as emulsions that are difficult to break pose a serious problem in oil recovery operations. In another distinct oilfield application, conformance control, silica gel and cross-linked/gelled polymer systems singly or in combination have been used. The basic idea is to form a gel, usually in the near wellbore areas, so as to block high permeability zones—fissures and crevices—that cause significant fluid losses. Thus these gelled systems are also termed water blocking or permeability modification agents. Examples include U.S. Pat. Nos. 4,332,297, 3,759,326, and 3,965,986. In flooding applications, however, the goal is to displace residual oil with a flowing displacing fluid.

To disperse NPs effectively is important and a subject of research. Rudyak notes that “in almost all studies, nanofluids are prepared using the so-called two-step method, in which a nanopowder containing particles of a given size is added in a certain ratio to the carrier (base) fluid.” In laboratory studies, samples are prepared in small batches, and ultrasonication is a standard method to disperse NPs. In oil and gas industrial applications where large quantities of servicing fluids, on the order of hundreds or thousands of gallons, are required for a single project, industrial ultrasonication equipment can be used to ensure proper dispersion and deagglomeration of NPs. Nguyen and Evonik's Bulletin 11 describe and differentiate among primary particles, aggregates (secondary particles), and agglomerates, and their sizes (Nguyen, V. S. et al., Ultrasonics Sonochemistry 21: 149-153 (2014), p. 149 and elsewhere; “Basic characteristics of AEROSIL® fumed silica,” Technical Bulletin Fine Particles 11, Evonik Industries, 2006, p. 20 FIG. 16, p. 26 FIG. 26, pp. 20-26). Aggregates are formed by primary particles contacting each other at surfaces and edges, while agglomerates by aggregates and/or primary particles contacting each other at points. In a liquid phase containing fumed metal oxides and likely also NPs synthesized by other methods, agglomerates can be reduced to aggregates by ultrasonication, shear stress, or other means, but aggregates cannot ordinarily be reduced to primary particles. McElfresh discloses that a surfactant-stabilized nanoparticle dispersion (NPD) using surface modified silica NPs with a primary particle size of 30 nm will at 100° C. agglomerate at a pH greater than 9.4 but be stable at pH 3, having a size up to 331 nm if in API brine (McElfresh, P. et al., SPE 154758, Society of Petroleum Engineers (2012)). Therefore, NPs that are not effectively dispersed or deagglomerated in a carrier fluid will exist in significant fractions as agglomerated particles or clusters in the size range of large colloidal particles, about 0.3 or 0.4 to 1 μm. As used herein agglomerates include aggregates.

### SUMMARY

We have discovered that a dispersion comprising hydrophobically modified polyacrylamide (HMPAM), known also as associative polymers, and small particles is effective in improving oil recovery from porous media, and unexpectedly more effective than either an HMPAM solution alone or a dispersion containing only the small particles. Small particles encompass those having primary particle sizes in the nanoparticle range. Advantages of the present invention include synergistic recovery benefits, potential operation cost reduction, and shortened flooding operation time and simplified operation logistics. Preferred non-limiting embodiments include those using metal oxide small particles, including fumed silica.

### BRIEF DESCRIPTIONS OF THE DRAWINGS

FIG. 1 is a graph showing the effect of small particles, at 0.1% and 0.25% by weight, on the shear rate dependent rheology of associative polymer AP158.

### DESCRIPTION OF THE PREFERRED EMBODIMENTS

The present invention relates to compositions and methods that may be useful in hydrocarbon recovery from subterranean formations, and more specifically to dispersions comprising hydrophobically modified polyacrylamide (HMPAM) or associative polymers and small particles, which encompass particles having primary particle sizes in the nanoparticle (NP) range to those with sizes of colloidal particles, and associated methods of use.

While some advantages are disclosed, not all advantages will be discussed herein. A dispersion of the present invention comprises at least one associative polymer and at least one small particle, the particles include but are not limited to metal oxides. We have discovered that these dispersions/suspensions are unexpectedly more effective than either the polymers or the particles alone in mobilizing oil from a porous medium. This effectiveness results in the advantage of using a lower concentration of specially synthesized polymers in hydrocarbon recovery operations, the polymers being sometimes more expensive than the particles. Alternatively, at the same typical polymer concentration, recovery can be more effective. The extra oil mobilization associated with our present invention does not significantly rely on macroscopic viscosity modification of the displacing fluid, the dispersion in this case, and the small particle concentration used is low. “Small particles” as used in this disclosure is generic, referring to particles in a range from nanoparticles having a primary particle size less than about 100 nm or 50 nm, to colloidal particles or aggregate/agglomerate particle clusters, especially those dispersed or suspended in a liquid carrier as explained in the disclosure, and having a size up to about 1 μm.

The small particles of the present application are those usually dispersed or suspended in a carrier or base fluid, and having an average primary particle size less than about 100 nm, preferably less than 50 nm. Particles in this size range are known as nanoparticles (NPs). They can be any of various metal oxides and include though not limited to, silicon oxide (silica) or aluminum oxide (alumina) for example. They can also be functionalized, for example through silanization, and be hydrophilically or hydrophobically functionalized. The polymer-particles dispersion comprises preferably at least one silica, particularly silica NPs. Silica NPs used in the present invention do not include precipitated silica, but do encompass and preferably, fumed (or pyrogenic) silica. Fumed silica and certain other metal oxide NPs exist in significant proportions as three-dimensional aggregates of fused, highly branched chains of quite uniform primary spherical nanoparticles (of about 7-50 nm in size, there being about 10-30 nanoparticles per chain). The three-dimensional chained aggregates are about 0.1-0.2 μm or alternatively about 0.2-0.3 μm long, having an estimated 3.5-4.5 hydroxyl groups per square nanometer silica surface for a theoretical maximum of 7.85 (for fumed silica).

The invention encompasses small particles either in the form of primary particles or aggregates/agglomerates. Agglomerates and also aggregates form when nanoparticles or nanopowders are dispersed or suspended in a carrier or base fluid. This fluid is preferably aqueous, for example water, brine, or a polymer solution. The aggregates or agglomerates can be in a size range in which one length dimension is between about 0.4 to about 1 μm, viz. the submicron range (which is also alternatively delimited as approximately 0.2-1 μm). At least one small particle or metal oxide of the invention preferably has an average agglomerate particle size less than about 0.4 μm, alternatively less than about 0.3 μm, and further alternatively less than about 0.2 μm. As used herein, agglomerates include aggregates, unless one or the other is indicated explicitly or otherwise by context clearly.

Aggregates are formed by primary particles contacting each other at surfaces and edges, while agglomerates by aggregates and/or primary particles contacting each other at points. In this context aggregates and agglomerates are secondary particles. In a carrier fluid especially aqueous containing fumed metal oxides NPs as well as NPs synthesized by other methods, agglomerates can be reduced to aggregates by ultrasonication, shear stress, or other means, but aggregates cannot ordinarily be reduced to primary particles. Therefore, NPs that are not effectively dispersed or deagglomerated in a carrier fluid will exist in significant fractions as agglomerated particles or clusters in the size range of large colloidal particles, about 0.3 or 0.4 to 1 μm, while those that are more effectively deagglomerated will exist in significant fractions as aggregates in sizes less than about 0.4 μm, or also less than about 0.3 μm, or further also less than about 0.2 μm. (In the case of certain metal oxides, including but not limited to fumed metal oxides such as fumed silica, the small particles as already described already exist significantly as fused chain aggregates prior to introduction to the carrier fluid, and once in the liquid carrier participate in a further aggregation and agglomeration process.) Preferred embodiments include a polymer-particles dispersion wherein at least one small particle, or metal oxide, or silica has particles of an average primary particle size less than about 50 nm, and also one of particles of an average agglomerate particle size less than about 400 nm.

Within a certain aggregate size range, nanoparticle aggregation and agglomeration in a liquid carrier is a reversible process, and depends on interparticle forces, carrier fluid conditions, and shearing. In a reversibly or weakly aggregated or flocculated dispersion system, aggregates of primary particles in branched fractal clusters are termed flocs. In such a case, some of the basic units contributing to the colloidal system properties are therefore flocs, not individual primary particles. Certain small particles—polymer dispersions are weakly aggregated or flocculated systems, and the present invention encompasses such systems. The extent of particle aggregation depends on the interparticle bond energy U_{b}, which is in the range of 10-20 k_{B}T for a weakly aggregated dispersion (k_{B} is the Boltzmann constant, and T the absolute temperature). Generally little flocculation occurs if U_{b} is less than about 10 k_{B}T, as Brownian motion will keep the particles apart. The rheology of a weakly aggregated dispersion or suspension can be affected by shear history, even when particle concentration is below the percolation threshold or gel point φ_{g}, when clusters interconnect into a network. Polymer concentration in the polymer-particles dispersions of our invention is generally in the dilute regime, from very dilute to semidilute, while existence of a concentrated regime is not excluded. That polymers in such regimes, especially associative polymers, can induce a reversibly or weakly flocculated or aggregated colloidal system when combined with nanoparticles is an encompassed embodiment of the invention. In weakly flocculated systems, agglomerated flocs can disintegrate relatively easily by shear flow, and are considered unlikely to lead to permanent pore plugging.

Associative or HMPAM polymers suitable for the present invention may be synthesized utilizing any suitable technique. Examples of the HMPAM class of EOR polymers include those disclosed by U.S. Pat. Nos. 4,694,046, 4,694,058, 4,814,096, 5,071,934, 7,700,702, and 8,420,576, and U.S. patent application Ser. No. 12/429,137. The relevant disclosures of each which, with respect to associative or HMPAM polymers and their chemical and polymeric structures, and especially with respect to the hydrophobic monomers they incorporate and any related details concerning properties that such incorporation imparts to the end product polymers, are incorporated by reference thereto as if fully set forth herein. Hydrophobic monomers suitable for the copolymerization of a hydrophobically associating copolymer are also disclosed in Canadian Pat. Appl. 2818089. One of the monomers disclosed therein that is suitable for the present invention has a structure represented by the general formula H2C═C(R1)-R3-O—(CH2-CH2-O)k—(CH2-CH(R4)l-O)—R5, where R3 is a single bond or a divalent linking group selected from the group consisting of —(CnH2n)-, —O—(Cn′H2n′)-, —CO—O—(Cn″H2n″)-, and —CO—NH—(Cn′″H2n′″)-, where n, n′, n″, and n′″ are each integers from 1 to 6; R4 is each independently a hydrocarbyl radical having at least 2 carbon atoms; R5 is H or a C1-30-hydrocarbyl radical, preferably a C1-5-alkyl radical and a particularly H; k=6 to 150; and 1=5 to 25.

Suitable associative or HMPAM polymers are preferably reaction products comprising the following generally monoethylenically unsaturated types of monomers: at least one acrylamide-derived non-ionic monomer; at least one anionic monomer containing acrylic, vinyl, maleic, fumaric or allyl functionalities, preferably acrylic and methacrylic, and containing a group selected from carboxy, phosphonate or sulfonates and/or their ammonium salts or alkaline-earth metal salts or alkali metal salts; and at least one hydrophobic monomer. Or the associative or HMPAM polymers comprise repeating monomeric units of the above types. The polymer backbone can be formed form acrylamide or acrylamide-based or -derived non-ionic monomers. The anionic monomeric units can be obtained from a partial hydrolysis reaction of the acrylamide-derived backbone with a base, where the extent of hydrolysis is preferably from about 15% to about 35%. Or the anionic monomer is an organic acid salt; the organic acid can be selected from the group consisting of acrylic acid, methacrylic acid, maleic acid, itaconic acid, acrylamido methylpropane sulfonic acid, vinylphosphonic acid, styrene sulfonic acid, and derivatives thereof A preferred embodiment includes polymeric products from a reaction comprising at least one acrylamide-derived non-ionic monomer and at least one hydrophobic monomer. Associative or HMPAM polymers of the present invention can reduce oil/aqueous phases IFT, down to about 0.1 dyne/cm or sometimes lower.

A hydrophobic monomer comprises a significant fraction of alkyl, aryl and/or aralkyl groups relative to other groups or functions. The overall hydrophobicity of a given hydrophobic monomer can vary, modulated by charged or polar functions that may be present as part of the hydrophobic monomer at internal and/or terminal positions. A hydrophobic monomer can be one comprising a hydrophobic moiety selected from the group consisting of anionic, cationic, nonionic, zwitterionic, betaine, and amphoteric ion pair.

In a preferred embodiment, the hydrophobic monomer is a monoethylenically unsaturated monomer, preferably (meth)acrylamide or (meth)acrylate, possessing an aliphatic and/or aromatic, straight chain or branched hydrocarbyl radical (e.g. isodecyl acrylate, 4-tert-butylcyclohexyl acrylate, or phenyl methacrylate), or such a hydrocarbyl radical further containing any of several functional groups or moieties including, but not limited to, ether (e.g. N-(isobutoxymethyl)acrylamide), amine, especially tertiary (e.g. 3-(dimethylamino)propyl acrylate), alcohol (e.g. N-acryloylamido-ethoxyethanol), ketone (e.g. N-(1,1-dimethyl-3-oxybutyl)acrylamide), amide (e.g. 2-[[(butylamino)carbonyl]oxy]ethyl acrylate), ester (e.g. 4-acetoxyphenethyl acrylate), carboxylic acid (2-carboxyethyl acrylate), sulfonic acid and salts thereof, especially sodium and potassium (e.g. 3-sulfopropyl methacrylate potassium salt), and quaternary ammonium halide salts (e.g. (3-acrylamidopropyl)trimethylammonium chloride or 2-(dimethylamino)ethylacrylate, methyl chloride quaternary salt), including bis-quaternary ammonium gemini, and quaternary ammonium sulfonic acid inner salt (e.g. [3-(methacryloylamino)propyl]dimethyl(3-sulfopropyl) ammonium hydroxide inner salt), where the inclusion of more than one functional group is possible. The monoethylenically unsaturated monomer can also possess bridged bicyclo, polyalkoxyl, polyarylphenol side chain groups. The monoethylenically unsaturated monomer can further possess alkoxylated, preferably ethoxylated or propoxylated, alkyl, aryl or aralkyl side chains, represented for example by the general formula H2C═C(R1)-CO—O—(CH2-CH2-O)k-R5, where k is an integer from 6 to 150, preferably 4 to 40, and R5 is a C4-40 alkyl, aryl or aralkyl group. The connection from the monoethylenically unsaturated backbone to the hydrocarbyl radical or functionalized (including alkoxylated) hydrocarbyl radical side group can be via a linkage that is alkyl, ether, carboxy, or amide.

Preferred hydrophobic monomers can be represented by a general formula selected from the group consisting of H2C═C(R1)-P-Q-R2 and H2C═C(R1)-CO—O—(CH2-CH2-O)k-R5. In the first formulas, R1 is H or an alkyl chain containing 1 to 4 carbons; P is a single bond or a divalent linking group selected from the group consisting of —O—, —CO—O—, and —CO—NH—; Q is a C1-10 alkyl, aryl or aralkyl divalent linking group; R2 is a group selected from the group consisting of —R3, —O—R3, —N(R4a)(R4b), —CO—R3, —CO—NH—R3, —O—CO—NH—R3, —O—CO—R3, -Q′-CO—OH, -Q′-CO—O⁻.W⁺, -Q′-SO3H, -Q′-SO3⁻.W⁺, —N⁺(R4a)(R4b)(R4c).X⁻, —N⁺(R4a)(R4b)-(CH2)2-O—(CH2)2-N⁺(R4a)(R4b)(R4c).X⁻, —N⁺(R4a)(R4c)-Q′-SO3[.W⁺] (brackets indicating optional), and —(CH)(N(R4a)(R4c))(CO—OH), where R3 is H or a C1-30 alkyl, aryl or aralkyl group or a C1-30 alkyl, aryl or aralkyl group containing one or more hydroxyl groups, Q′ is a C1-10 alkyl, aryl or aralkyl divalent linking group, R4a and R4c are each independently H or a C1-4 alkyl, R4b is a C1-30 alkyl, aryl or aralkyl group, W⁺ is a counterion with a positive charge, and X⁻ is a counterion with a negative charge. In the second formula, k is an integer from 6 to 150, preferably 4 to 40, and R5 is a C4-40 alkyl, aryl or aralkyl group. For a hydrophobic monomer having the first general formula H2C═C(R1)-P-Q-R2, the total number of alkyl, aryl and aralkyl carbons in Q and R2 together is at least 4, preferably at least 6, and also preferably at least 8.

The small particles of the polymer-particles dispersion disclosed herein, preferably silica, is present in the dispersion in an amount in the range of about 0.005% to about 0.5% by weight of the dispersion, preferably in the range of about 0.01-0.2% by weight of the dispersion. In preferred embodiments, the associative or HMPAM polymers of the disclosed dispersion has a weight average molecular weight (MW) greater than about 500,000 g/mol, especially greater than about 800,000 g/mol, and is present in the dispersion in an amount in the range of about 0.05% to about 2% by weight of the dispersion, equivalent to about 500 ppm-20,000 ppm. The reaction from which the associative polymer is formed comprises between about 30 and 90 mole % of at least one acrylamide-derived non-ionic monomer; between about 10 and 60 mole % of at least one anionic monomer, preferably between about 20 and 55 mole %; and between about 0.005 and 15 mole % of at least one hydrophobic monomer, preferably between about 0.05 and 15 mole %. The amount of associative polymer of the dispersion used in flooding operations can be from about 200 mg/L·PV to about 600 mg/L·PV.

An EOR flooding process employing the polymer-particles dispersion composition described can be used to recover hydrocarbons and comprises, supplying a pre-formulated dispersion as described or one made on-site, injecting said dispersion into either an injection or production well having access to a hydrocarbon reservoir, and recovering produced fluids from the production well. Optionally, brine flushes, chases, or slugs containing various EOR chemical combinations can be included in the oil recovery process to achieve any of various purposes, for example to remove plugging, or to perform hydraulic fracturing to improve polymer and/or dispersion injectivity and productivity for low-permeability wells.

While the compositions and processes described herein are not limited to reservoirs of a given temperature, they are particularly useful in reservoirs having an ambient temperature ranging from about 10 to 120° C., and especially from about 20 to about 95° C. Compositions and processes disclosed herein can be used/performed under alkaline conditions, where the pH of the dispersion or separate injection fluid used in the EOR processes is stably adjusted and maintained to be greater than about 6 using salts of (bi)carbonate, hydroxide, silicate and other bases at sufficient and suitable concentrations suitable for EOR alkali flooding. The associative polymers and small particles mixture of the present invention can be supplied as a water dispersion, as part of a liquid emulsion, or as a solid powder (mixture), and if in the last form be made into a dispersion or suspension (which is a coarse dispersion) involving various processes comprising proration, dispersion, maturation, transportation, filtration, and storage, and can optionally further incorporate stabilizing or suspending agents or anti flocculating agents in liquid or dry form including, but not limited to, any of various surfactants, urea, sodium carboxymethylcellulose, xanthan gum, carrageenan, bentonite, and ammonium pyrophosphate and related compounds as disclosed in U.S. Pat. No. 7,803,858, the relevant disclosures of which are incorporated by reference herein. The dispersions disclosed herein can be stable for hours. Its stability can be improved by further including suspending agents or anti flocculants. In a process using such a dispersion, the suspending or anti flocculating agents can be included with the dispersion or injected in a separate slug/flush. Preferably the dispersion is made with a less saline water. While not a limiting factor, advantageously the compositions and processes described herein are made/conducted in the presence of brine salinities of less than about 350,000 mg/L total dissolved solids (TDS), and more advantageously when the salinity is less than about 150,000 mg/L TDS. The dispersion of the present invention can be made using produced water and be rejected. The compositions and processes of the invention can be used for reservoirs with an average permeability of 100 mD to 150 D, preferably of 150 mD to 50 D or alternatively 200 mD to 10 D.

### EXAMPLES

In order to demonstrate that using the dispersions of the present invention can result in improved hydrocarbon recovery, several dispersion samples comprising small particles and associative/hydrophobically modified polymers were prepared, and their ability to recover oil from a sandpack column was measured compared to controls in the following examples. Shear rate dependent viscosity curves are also presented. These examples should in no way be read to limit, or to define, the entire scope of the invention.

The associative/hydrophobically modified polymers used were synthesized by a free radical reaction. A typical polymerization method is as follows: Monomers are weighed and dissolved in water; surfactants and other additives are introduced to the monomer solution next, and well stirred until a homogeneous phase is obtained; the mixture is nitrogen purged for about one hour; then a redox initiator pair is introduced to initiate polymerization at 25° C.; after a 2-hour reaction, the polymer gel is cut into small pieces and dried at 60° C. overnight; and the dried polymer is ground to a fine powder of about 50-100 mesh under a nitrogen atmosphere. Prepared for illustrative purposes, the two associative polymer samples have the following compositions (all mole percentages and about): AP158 is formed from a polymerization reaction comprising 39 mole % of acrylamide, 49 mole % of acrylic acid, and 12 mole % total of three hydrophobic monomers consisting of N-(1,1-dimethyl-3-oxybutyl)acrylamide, 2-(dimethylamino)ethylacrylate, methyl chloride quaternary salt, and an ethoxylated alkyl methacrylate of the formula H2C═C(CH3)-CO—O—(CH2-CH2-O)k-R5, where k is 4-40, and R5 is a C4-40 alkyl group; and AP96 is formed from a polymerization reaction comprising 69 mole % of acrylamide, 30 mole % of acrylic acid, and 0.18 mole % of an ethoxylated alkyl methacrylate of the formula H2C═C(CH3)-CO—O—(CH2-CH2-O)k-R5, where k is 4-40, and R5 is a C4-40 alkyl group.

Parameters for the sandpack columns are as follows: Packing is with Silica Sand F-95 w/o sieving; the column is 16 cm×0.64 cm length×ID; PV is 2.4 to 2.8 mL; and permeability (k_{w}) is 3000 to 4000 mD. A general experimental procedure is as follows: Fill the column with sand and pack the column; repeat until column cannot be packed any further; vibrate the column to pack further; saturate the column with brine and weigh it before and after, the difference taken as the pore volume; next inject into the column a selected oil at a desired rate at two pore volumes, sufficient for oil saturation, and collect the effluent stream into a graduated cylinder (being finely marked, this and all others), where the amount of displaced brine is taken as a laboratory representation of original oil in place (OOIP); then push with brine initially at two pore volumes at the same rate as before, and collect into a different cylinder, followed by one pore volume of a chemical or dispersion being tested at the same rate and collecting; finally flush with one pore volume of brine and collecting; the amount of oil recovered from the chemical and final brine injections together over OOIP is % OOIP. In sequential injections, the final brine flush is replaced with either a polymer solution or a particles dispersion.

Table 1 presents sandpack experiment data that will be referred to in the examples below. Notes: (a) Column 2 delineates respectively the particle, associative polymer, and oil used, where between a particle and a polymer a forward slash indicates a single mixed dispersion injected during the chemical step, while a hyphen indicates sequential injections and the order thereof, and a bare underline indicates either no particles or no polymer was used; (b) A200 eq is AEROSIL-200 from Evonik/Degussa, or any equivalent fumed silica from other vendors having a primary particle size less than 20 nm and a BET specific surface area of 200 m²/g; (c) when associative polymer was used, it was made at 2000 ppm final in the formation brine from where the oil originated, unless indicated otherwise; AP158 and AP96 are as described above; (d) in Experiments 13-15, AP96 concentration was 800 ppm final, brine was 1% KCl, and dispersion was buffered by a 200 mM bicarbonate system, pH 8; (e) in mixed dispersions, an associative polymer stock solution was mixed with an ultrasonicated particles stock dispersion to desired final concentrations, and allowed to stir at high speed until stable; final dispersions were stable for many hours; (f) IL is a light crude from the Illinois Basin, and WR is an API gravity 36 crude (dead oil viscosity 2.3 cP) from Wilson County, Texas.

TABLE 1

| Experiment # | Particle/Polymer/Oil | Particle conc. (wt %) | % OOIP |
|---|---|---|---|
| 1 | A200eq/______/IL | 0.050% | 5.8% |
| 2 | ______/AP158/IL | N/A | 16.7% |
| 3 | A200eq/AP158/IL | 0.006% | 16.0% |
| 4 | A200eq/AP158/IL | 0.006% | 15.4% |
| 5 | A200eq/AP158/IL | 0.050% | 20.8% |
| 6 | A200eq/AP158/IL | 0.050% | 26.1% |
| 7 | A200eq/AP158/IL | 0.050% | 20.0% |
| 8 | A200eq-AP158/IL | 0.050% | 14.6% |
| 9 | AP158-A200eq/IL | 0.050% | 17.5% |
| 10 | A200eq/______/WR | 0.050% | 6.0% |
| 11 | ______/AP158/WR | N/A | 16.8% |
| 12 | A200eq/AP158/WR | 0.050% | 23.9% |
| 13 | A200eq/______/IL | 0.050% | 14.0% |
| 14 | ______/AP96/IL | N/A | 25.0% |
| 15 | A200eq/AP96/IL | 0.050% | 29.2% |

### Example 1

Experiments 1-7 constitute Example 1. They show that fumed silica with nanosized primary particles less than 20 nm at 0.05 weight % is not effective in recovering oil by itself; that an associative polymer-particles dispersion, at 0.006 weight % particle concentration, is no more effective than the polymer by itself, but at 0.05 weight % particle concentration is more effective by about 4 to 10% OOIP.

### Example 2

Experiments 1-2 and 5-9 constitute Example 2. They demonstrate that the greater oil recovery of the associative polymer-particles dispersion, as compared to the polymer solution and particles dispersion each alone, requires that the two species be present in a single mixed dispersion, as injections in sequence in either order do not yield the extra recovery, but give % OOIP in the 14.6-17.5% range, similar to that for the polymer solution only case.

### Example 3

Experiments 10-12 constitute Example 3. They show that the synergistic benefit of the associative polymer-particles dispersion can be observed for a different crude oil WR, not just IL.

### Example 4

Experiments 13-15, conducted in a pH 8 bicarbonate system as indicated in the notes to Table 1, constitute Example 4. These show polymer AP96 to produce a synergistic benefit of about 4% OOIP when used in a mixed dispersion of the invention as disclosed herein, and further, that the invention is compatible with and can be practiced in an alkaline system.

### Example 5

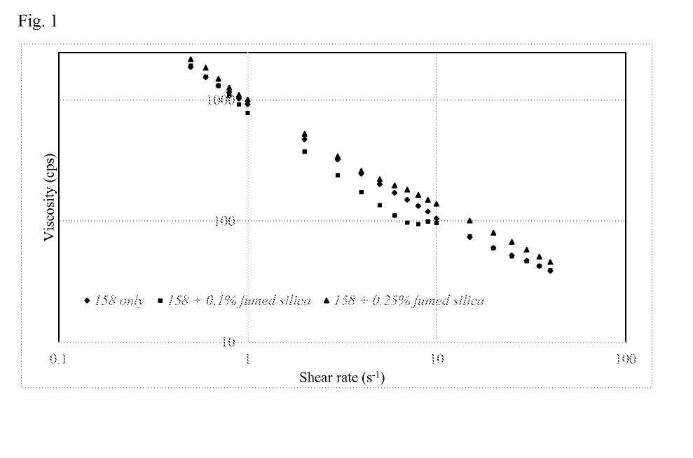

In this example, the results of which is shown in FIG. 1, the effect of small particles, at 0.1% and 0.25% by weight (squares and up triangles), on the shear rate dependent rheology of associative polymer AP158 was examined (diamonds for AP158 only). The small particles are fumed silica that is an AEROSIL-200 equivalent, having a primary particle size less than 20 nm and a BET specific surface area of 200 m²/g. Viscosity was measured using a Grace M5600 rheometer at an associative polymer concentration of 2000 ppm, and plotted on the y-axis, with shear rate plotted on the x-axis, both in logarithmic scale. All tests were carried out at 35° C. and in 1% KCl, and the equilibration time for each data point was 240 seconds. The results show that small particles addition at percentages used for the invention produces small differences in dispersion viscosity, with the greatest difference around 7-8 per second, about 30 cps, or a 20% range of difference. It is noted that oil recovery experiments via sandpack columns in previous examples use a particle concentration that is lower than those in this example, so the dispersion viscosity change/variation would be expected to be even less. Therefore, any bulk viscosity changes do not make a significant contribution to the improved oil recovery benefits achieved by the system of the invention disclosed herein. This is unlike and in contrast to what is disclosed in prior art such as U.S. Pat. No. 6,586,371 and WO 2014/020061.

In light of the above disclosure, those skilled in the art will understand how to create such a combined dispersion as will include suitable associative polymers and small particles, and still perform other intended EOR treatments and create an initially formulated system wherein all of the chemical components are compatible with one another. Advantages to having a single combined flooding fluid for a particular stage of an EOR operation include these: (1) the time required to perform functions that would be achieved by individual chemicals/agents is shorter; (2) the logistics of implementing the flooding process in the field is simpler than if one process is performed followed by a different one; and (3) there can be synergistic benefits in the oil recovery performance of the polymers plus particles EOR system than if each is implemented by itself.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. Further, it is intended that the appended claims do not limit the scope of the above disclosure, and can be amended to include features hereby provided for within the present disclosure. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number or any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an”, as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

What is claimed is:

1. A dispersion for recovering hydrocarbons from a subterranean formation, comprising:
at least one associative polymer formed from a reaction comprising: at least one acrylamide-derived non-ionic monomer; at least one anionic monomer containing acrylic, vinyl, maleic, fumaric or allyl functionalities and containing a group selected from carboxy, phosphonate or sulfonates and/or their ammonium salts or alkaline-earth metal salts or alkali metal salts; and at least one hydrophobic monomer; and
at least one silica.

2. The dispersion of claim 1, wherein the at least one silica has particles of an average primary particle size less than about 50 nm, and wherein the hydrophobic monomer has a general formula selected from the group consisting of H2C═C(R1)-P-Q-R2 and H2C═C(R1)-CO—O—(CH2-CH2-O)k-R5,
where R1 is H or an alkyl chain containing 1 to 4 carbons; P is a single bond or a divalent linking group selected from the group consisting of —O—, —CO—O—, and —CO—NH—; Q is a C1-10 alkyl, aryl or aralkyl divalent linking group; R2 is a group selected from the group consisting of —R3, —O—R3, —N(R4a)(R4b), —CO—R3, —CO—NH—R3, —O—CO—NH—R3, —O—CO—R3, -Q′-CO—OH, -Q′-CO—O⁻.W⁺, -Q′-SO3H, -Q′-SO3⁻.W⁺, —N⁺(R4a)(R4b)(R4c).X⁻, —N⁺(R4a)(R4b)-(CH2)2-O—(CH2)2-N⁺(R4a)(R4b)(R4c).X⁻, —N⁺(R4a)(R4c)-Q′-SO3⁻[.W⁺], and —(CH)(N(R4a)(R4c))(CO—OH), where R3 is H or a C1-30 alkyl, aryl or aralkyl group or a C1-30 alkyl, aryl or aralkyl group containing one or more hydroxyl groups, Q′ is a C1-10 alkyl, aryl or aralkyl divalent linking group, R4a and R4c are each independently H or a C1-4 alkyl, R4b is a C1-30 alkyl, aryl or aralkyl group, W⁺ is a counterion with a positive charge, and X⁻ is a counterion with a negative charge;
where k is an integer from 6 to 150, and R5 is a C4-40 alkyl, aryl or aralkyl group; and
where for H2C═C(R1)-P-Q-R2, the total number of alkyl, aryl and aralkyl carbons in Q and R2 together is at least 4.

3. The dispersion of claim 1, wherein the at least one silica has particles of an average agglomerate particle size less than about 400 nm, and wherein the hydrophobic monomer has a general formula selected from the group consisting of H2C═C(R1)-P-Q-R2 and H2C═C(R1)-CO—O—(CH2-CH2-O)k-R5,
where R1 is H or an alkyl chain containing 1 to 4 carbons; P is a single bond or a divalent linking group selected from the group consisting of —O—, —CO—O—, and —CO—NH—; Q is a C1-10 alkyl, aryl or aralkyl divalent linking group; R2 is a group selected from the group consisting of —R3, —O—R3, —N(R4a)(R4b), —CO—R3, —CO—NH—R3, —O—CO—NH—R3, —O—CO—R3, -Q′-CO—OH, -Q′-CO—O⁻.W⁺, -Q′-SO3H, -Q′-SO3⁻.W⁺, —N⁺(R4a)(R4b)(R4c).X⁻, —N⁺(R4a)(R4b)-(CH2)2-O—(CH2)2-N⁺(R4a)(R4b)(R4c).X⁻, −N⁺(R4a)(R4c)-Q′-SO3[.W⁺], and —(CH)(N(R4a)(R4c))(CO—OH), where R3 is H or a C1-30 alkyl, aryl or aralkyl group or a C1-30 alkyl, aryl or aralkyl group containing one or more hydroxyl groups, Q′ is a C1-10 alkyl, aryl or aralkyl divalent linking group, R4a and R4c are each independently H or a C1-4 alkyl, R4b is a C1-30 alkyl, aryl or aralkyl group, W⁺ is a counterion with a positive charge, and X⁻ is a counterion with a negative charge;
where k is an integer from 6 to 150, and R5 is a C4-40 alkyl, aryl or aralkyl group; and
where for H2C═C(R1)-P-Q-R2, the total number of alkyl, aryl and aralkyl carbons in Q and R2 together is at least 4.

4. The dispersion of claim 2, wherein the at least one silica is present in the dispersion in an amount in the range of about 0.005% to about 0.5% by weight of the dispersion.

5. The dispersion of claim 3, wherein the at least one silica is present in the dispersion in an amount in the range of about 0.005% to about 0.5% by weight of the dispersion.

6. The dispersion of claim 2, wherein the silica is fumed silica.

7. The dispersion of claim 3, wherein the silica is fumed silica.

8. The dispersion of claim 2, wherein the at least one associative polymer has a weight average molecular weight (MW) greater than about 500,000 g/mol.

9. The dispersion of claim 3, wherein the at least one associative polymer has a weight average molecular weight (MW) greater than about 500,000 g/mol.

10. The dispersion of claim 2, wherein the reaction from which the at least one associative polymer is formed comprises: between about 30 and about 90 mole % of the acrylamide-derived non-ionic monomer; between about 10 and about 60 mole % of the anionic monomer; and between about 0.005 and about 15 mole % of the hydrophobic monomer.

11. The dispersion of claim 3, wherein the reaction from which the at least one associative polymer is formed comprises: between about 30 and about 90 mole % of the acrylamide-derived non-ionic monomer; between about 10 and about 60 mole % of the anionic monomer; and between about 0.005 and about 15 mole % of the hydrophobic monomer.

12. The dispersion of claim 2, wherein the at least one associative polymer is present in the dispersion in an amount in the range of about 0.05% to about 2% by weight of the dispersion.

13. The dispersion of claim 3, wherein the at least one associative polymer is present in the dispersion in an amount in the range of about 0.05% to about 2% by weight of the dispersion.

14. The dispersion of claim 2, wherein the anionic monomer is acrylic acid or methacrylic acid, and/or their ammonium salts or alkaline-earth metal salts or alkali metal salts.

15. The dispersion of claim 3, wherein the anionic monomer is acrylic acid or methacrylic acid, and/or their ammonium salts or alkaline-earth metal salts or alkali metal salts.

16. The dispersion of claim 1, further comprising an alkali salt at a sufficient concentration to adjust a pH of said dispersion to be stably greater than about 6.

17. The dispersion of claim 1, further comprising an anti flocculating or suspending agent.

18. A particulate mixture for recovering hydrocarbons from a subterranean formation, comprising:
at least one associative polymer formed from a reaction comprising: at least one acrylamide-derived non-ionic monomer; at least one anionic monomer containing acrylic, vinyl, maleic, fumaric or allyl functionalities and containing a group selected from carboxy, phosphonate or sulfonates and/or their ammonium salts or alkaline-earth metal salts or alkali metal salts; and at least one hydrophobic monomer; and
at least one silica.

19. A flooding process to recover hydrocarbons from a subterranean formation using the dispersion of claim 1, comprising: supplying the dispersion; injecting said dispersion into a first wellbore in contact with a hydrocarbon reservoir within the formation; and recovering produced fluids from the first wellbore or a second wellbore, also in contact with the reservoir.

20. A flooding process of claim 19, optionally comprising steps placed at any stage of the process selected from the group consisting of injecting a surfactant-based or surfactant micelle-based solution into the first wellbore, injecting an alkali solution into the first wellbore, injecting a permeability modification agent into the first wellbore, hydraulically fracturing the formation to improve injectivity or productivity, and any combinations thereof.
